(19) United States
(12) Patent Application Publication
(10) Pub. No.: US 2024/0086745 A1
(43) Pub. Date: Mar. 14, 2024

(54) DETERMINING PRINCIPAL COMPONENTS USING MULTI-AGENT INTERACTION

(71) Applicant: DeepMind Technologies Limited, London (GB)

(72) Inventors: Ian Michael Gemp, London (GB); Brian McWilliams, London (GB)

(21) Appl. No.: 18/275,045

(22) PCT Filed: Feb. 7, 2022
(86) PCT No.: PCT/EP2022/052894

§ 371 Date: Jul. 31, 2023

Related U.S. Application Data
(60) Provisional application No. 63/146,489, filed on Feb. 5, 2021.

(51) Int. Cl. G06N 7/01

(52) U.S. Cl. CPC G06N 7/01

(57) ABSTRACT

Methods, systems, and apparatus, including computer programs encoded on computer storage media, for determining principal components of a data set using multi-agent interactions. One of the methods includes obtaining initial estimates for a plurality of principal components of a data set; and generating a final estimate for each principal component by repeatedly performing operations comprising: generating a reward estimate using the current estimate of the principal component, wherein the reward estimate is larger if the current estimate of the principal component captures more variance in the data set; generating, for each parent principal component of the principal component, a punishment estimate, wherein the punishment estimate is larger if the current estimate of the principal component and the current estimate of the parent principal component are not orthogonal; and updating the current estimate of the principal component according to a difference between the reward estimate and the punishment estimates.

### BACKGROUND

This specification relates to principal component analysis. Principal component analysis (PCA) is a process of computing the principal components of a data set and using the computed principal components to perform a change of basis on the data set. PCA is used in exploratory data analysis and for making predictive models. PCA is commonly used for dimensionality reduction by projecting each data point onto only the first few principal components to obtain lower-dimensional data while preserving as much of the data's variation as possible.

### SUMMARY

This specification describes a system implemented as computer programs on one or more computers in one or more locations that determines the top-k principal components of a data set Xby modeling the principal component analysis as a multi-agent interaction.

The subject matter described in this specification can be implemented in particular embodiments so as to realize one or more of the following advantages.

Using techniques described in this specification, a system can efficiently and accurately estimate the top-k principal components of a data set X, e.g., using less time and/or fewer computational and/or memory resources than existing techniques for performing principal component analysis.

By parallelizing the computations of the agents across multiple processing devices, the system can further improve the efficiency of determining the principal components. Using techniques described herein, the system can further remove bias in the computations that would inherently exist in a naive parallelized implementation.

For example, using techniques described in this specification, a system can determine the top-k principal components of a data set, and use the top-k principal components of the data set to reduce the dimensionality of the data set for storage or further processing, improving the computational and memory efficiency of the storing the data set.

As another example, using techniques described in this specification, a system can determine the top-k principal components of a data set, and use the top-k principal components of the data set to reduce the dimensionality of the data set for performing machine learning on the data set, improving the computational and memory efficiency of the machine learning process.

Using techniques described in this specification, a system can determine the top-k principal components of a data set more quickly and more accurately than some other existing techniques. For example, a system can achieve a longer “longest correct eigenvector streak” (which measures the number of eigenvectors that have been determined, in order, to within an angular threshold of the ground-truth eigenvectors) than existing techniques (e.g., a 10%, 50%, or 100% longer streak) more quickly (e.g., in 10%, 15%, or 25% fewer seconds) than the existing techniques.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1A is a diagram of an example principal component analysis system for sequentially determining principal components of a data set.

FIG. 1B is a flow diagram of an example process for sequentially determining principal components of a data set.

FIG. 2A is a diagram of an example principal component analysis system for determining principal components of a data set in parallel.

FIG. 2B is a flow diagram of an example process for determining principal components of a data set in parallel.

FIG. 3 is a diagram of an example system that includes a principal component analysis system.

FIG. 4 is a flow diagram of an example process for determining the top-k principal components of a data set.

FIG. 5 is an illustration of the performance of respective different principal component analysis systems determining the principal components of a data set.

Like reference numbers and designations in the various drawings indicate like elements.

### DETAILED DESCRIPTION

This specification describes a system implemented as computer programs on one or more computers in one or more locations that is configured to determine the top-k principal components of a data set X by modeling the principal component analysis as a multi-agent interaction. The data set X may comprise (or consist of) a plurality of data elements, e.g. text terms, images, audio samples, or other items of sensor data.

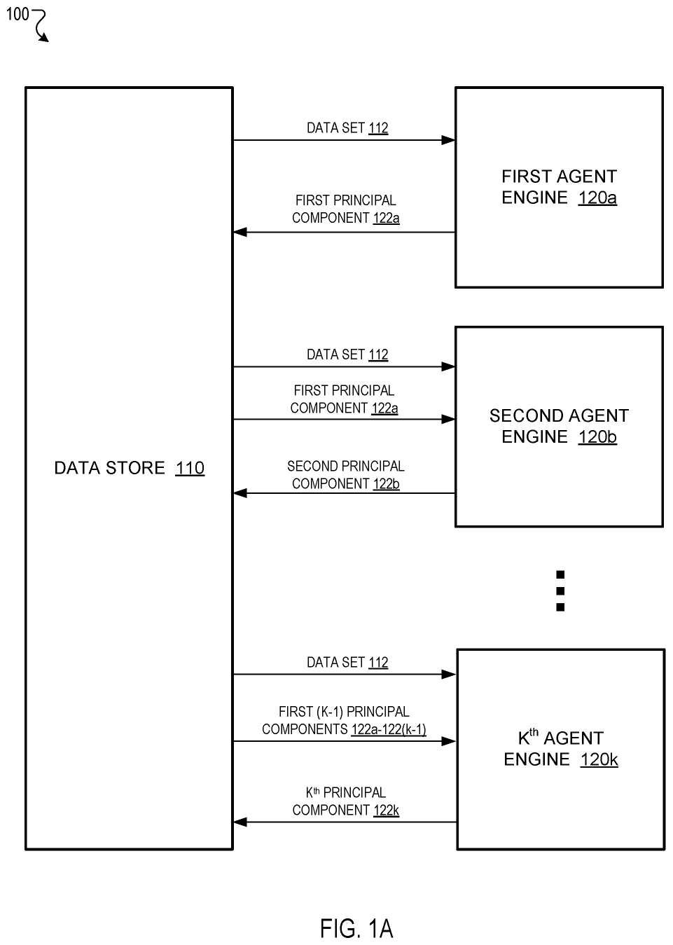

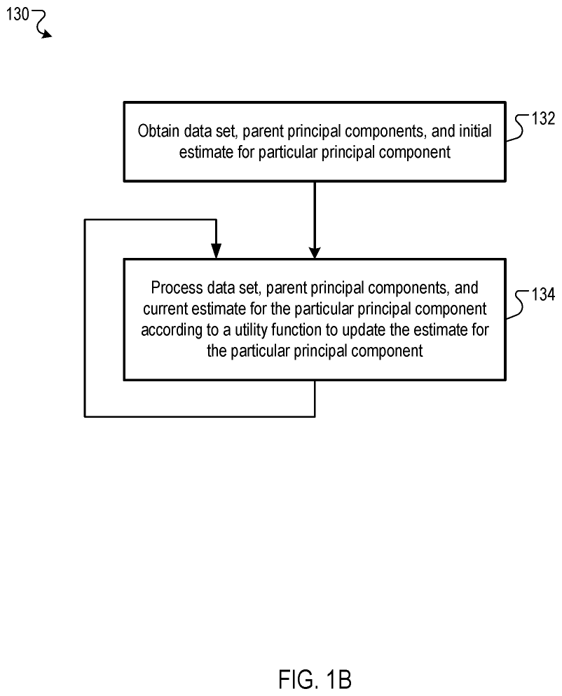

FIG. 1A is a diagram of an example principal component analysis system 100. The principal component analysis system 100 is an example of a system implemented as computer programs on one or more computers in one or more locations, in which the systems, components, and techniques described below can be implemented.

The principal component analysis system 100 is configured to determine the top-k principal components 122a-k of a data set 112, where k≥1. The data set 112 has dimensionality n, where n>k. That is, each element of the data set 112 has dimensionality n, e.g., such that each element can be represented by a vector of length n.

The principal components of a data set X in [symbol] ⁿ are vectors in [symbol] ⁿ that align with the directions of maximum variance of the data set X and that are orthogonal to each other. The top-k principal components may be collectively denoted v.

The principal component analysis system 100 is configured to determine the top-k principal components 122a-k sequentially, in descending order of the principal components (i.e., first determining the first principal component, then the second principal component, and so on).

In this specification, the n^{th} principal component of a data set is the principal component identifying the direction of the n^{th} largest variance in the data set (equivalently, the principal component corresponding to the n^{th} largest eigenvalue of the covariance matrix of the data set, where the covariance matrix is a square matrix that identifies the covariance between each pair of elements in the data set).

In this specification, the “parent” principal components of a particular principal component are the principal components that are higher than the particular principal component in the ranking of principal components; i.e., the parent principal components identify directions of higher variance than the direction identified by the particular principal component (equivalently, the parent principal component have larger corresponding eigenvalues than the eigenvalue of the particular principal component). The “child” principal components of a particular principal component are the principal components that are lower than the particular principal component in the ranking of principal components.

The principal component analysis system 100 determines the top-k principal components 122a-k by modelling the principal component analysis as a multi-agent interaction. The multi-agent interaction includes k agents, each agent corresponding to a respective principal component 122a-k.

Each agent in the multi-agent interaction takes an action by selecting an estimate of the corresponding principal component 122a-k, and receives a reward for the action that incentivizes the agent to select the true corresponding principal component 122a-k. In particular, the principal component analysis system 100 defines a utility function for each agent that is a function of (i) the estimate of the corresponding principal component 122a-k identified by the action of the agent and (ii) the parent principal components 122a-k of the corresponding principal component as identified by the respective actions of the corresponding other agents in the multi-agent interaction. The respective utility function of each agent can reward actions by the agent that identify estimated principal components 122a-k that (i) are orthogonal to the parent principal components 122a-k (as identified by the actions of the corresponding other agents) and (ii) identify a direction of maximal variance in the data set 112 (among the directions that are available given the parent principal components). Example utility functions are discussed in more detail below with reference to FIG. 1B.

Because the utility function of each agent corresponding to a particular principal component 122a-k only depends on the actions of the agents corresponding to parent principal components to the particular principal component 122a-k, the principal component analysis system 100 can determine the principal components 122a-k sequentially, i.e., by determining the action of the agent corresponding to the first principal component 122a, then the action of the agent corresponding to the second principal component 122b, and so on.

The principal component analysis system 100 includes a data store 110 and k agent engines 120a-k.

The data store 110 is configured to store the data set 112 and, as the principal components 122a-k are generated sequentially by the principal component analysis system 100, the principal components 122a-k that have been generated so far. The data store 110 can be distributed across multiple different logical and physical data storage locations.

Each agent engine 120a-k is configured to determine a respective principal component 122a-k of the data set 112 by selecting an action for the corresponding agent in the multi-agent interaction defined by the principal component analysis system 100. That is, the first agent engine 120a is configured to determine the first principal component 122a of the data set 112, the second agent engine 120b is configured to determine the second principal component 122b of the data set 112, and so on.

First, the data store 110 provides the data set 112 to the first agent engine 120a. The first agent engine 120a processes the data set 112, as described in more detail below, to generate the first principal component 122a. In particular, the first agent engine 120a processes the data set 112 to maximize the utility function of the agent in the multi-agent interaction corresponding to the first principal component 122a, selecting an action that represents the first principal component 122a. The first agent engine 120a then provides the first principal component 122a to the data store 110.

In some implementations, as described in more detail below, the first agent engine 120a iteratively selects an action (i.e., an estimate of the first principal component 122a), and updates the action according to the reward received for the action as defined by the utility function. That is, the first agent engine 120a can execute across multiple iterations in which the first agent 120a selects an action for the corresponding agent, and after the multiple iterations provides the estimate of the first principal component 122a identified by the action selected at the final iteration to the data store 110.

After receiving the first principal component 122a from the first agent engine 120a, the data store 110 provides the data set 112 and the first principal component 122a to the second agent engine 120a. The second agent engine 120b processes the data set 112 and the first principal component 122a, as described in more detail below, to generate the second principal component 122b. In particular, given the action of the agent corresponding to the first principal component 122a, the second agent engine 120b processes the data set 112 to maximize the utility function of the agent in the multi-agent interaction corresponding to the second principal component 122b, selecting an action that represents the second principal component 122b. The second agent engine 120b then provides the second principal component 122b to the data store 110.

Similar to the first agent engine 120a, in some implementations, the second agent engine 120b executes across multiple iterations in which the second agent 120b selects an action for the corresponding agent, and after the multiple iterations provides the estimate of the second principal component 122b identified by the action selected at the final iteration to the data store 110.

The agent engines 120a-k continue sequentially to generate the corresponding principal components 122a-k as described above until the k^{th} agent engine 120k determines the k^{th} principal component 122k from (i) the data set 112 and (ii) the first k−1 principal components 122a to 122(k−1), and provides the k^{th} principal component 122k to the data store 110.

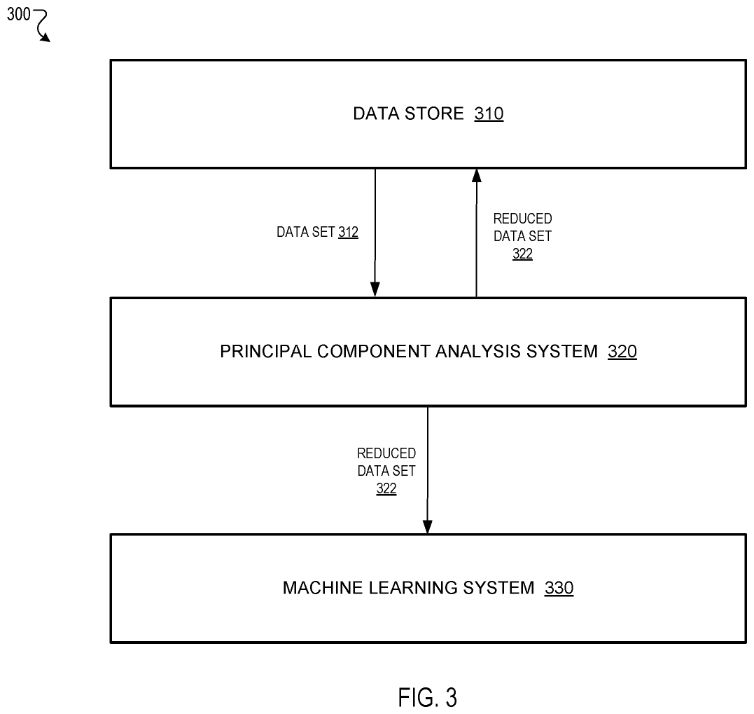

After determining the top-k principal components 122a-k, the principal component analysis system can provide the principal components 122a-k to an external system for storage or further processing. Example techniques for using the principal components 122a-k of a data set 112 are described below with reference to FIG. 3.

In some implementations, each agent engine 120a-k is implemented on a respective different processing device (“device”) in a system of multiple communicatively coupled devices. For example, each agent engine 120a-k can be implemented on a respective parallel processing device, e.g., a graphics processing unit (GPU), tensor processing unit (TPU), or central processing unit (CPU). In some other implementations, one or more of the agent engines 120a-k are implemented on the same device.

In some implementations, the operations executed by the agent engines 120a-kdescribed above are executed by the same component of the principal component analysis system 100, e.g., by a single agent engine. That is, in some implementations, the principal component analysis system 100 includes a single agent engine (e.g., that is implemented on a single device) that determines each of the top-k principal components 122a-k.

FIG. 1B is a flow diagram of an example process 130 for sequentially determining principal components of a data set. For convenience, the process 130 will be described as being performed by a system of one or more computers located in one or more locations. For example, a principal component analysis system, e.g., the principal component analysis system 100 depicted in FIG. 1A, appropriately programmed in accordance with this specification, can perform the process 130.

The system can repeat the process 130 described below for each top-k principal components of the data set sequentially. That is, the system can first execute the process 130 to determine a final estimate for the first principal component of the data set, then execute the process 130 to determine a final estimate for the second principal component of the data set, and so on. In the description below, the system is described as executing the process 130 to determine a particular principal component.

The system obtains the data set, the parent principal components to the particular principal component (if any; in the case of the first principal component (top principal component) there is no parent principal component), and an initial estimate for the particular principal component (step 132). The parent principal components can have been determined during previous executions of the process 130.

The system can determine any appropriate initial estimate for the particular principal component. For example, the system can randomly select an initial estimate, e.g., sampling a tensor having the same dimensionality as the data set uniformly at random. As another example, the system can select an initial estimate for the particular principal component by sampling a tensor that is orthogonal to each of the parent principal components.

The system can execute step 134 at each of multiple iterations to update the estimate for the particular principal component.

The system processes the data set, the parent principal components, and the current estimate for the particular principal component according to a utility function to update the estimate for the particular principal component (step 134).

The system models the determination of the particular principal component as a multi-agent interaction, where a particular agent performs an action that identifies an estimate for the particular principal components, and respective other agents in the multi-agent interaction perform actions that identify the parent principal components to the particular principal components. The system can update the selected action of the particular agent to update the estimate of the particular principal component.

The utility function defines the reward for the particular agent, where a higher reward indicates that the action selected by the particular agent identifies an estimate for the particular principal component that is closer to the true value for the particular principal component.

The utility function can include one or more first terms that reward the particular agent for selecting an estimate for the particular principal component that captures more variance in the data set. That is, the one or more first terms are larger if the estimate for the particular principal component captures more variance in the data set.

For example, the first term of the utility function can be equal to or proportional to:

∥X\hat{v}ᵢ∥²
where X is the data set, and \hat{v}ᵢ is the estimate of the particular principal component (i.e., the i^{th} principal component, where i is a positive integer) identified by the action of the particular agent.

Instead or in addition, the utility function can include one or more second terms that punish the particular agent for selecting an estimate for the particular principal component that is not orthogonal to the parent principal components (if any) of the particular principal component. For example, the utility function can include one such second term for each parent principal component.

For example, the second term of the utility function corresponding to a particular parent principal component (the j^{th} principal component, where j is a positive integer less than i) to the particular principal component can be equal to or proportional to:

$$\frac{{〈 X {\hat{v}}_{i} , X {\hat{v}}_{j} 〉}^{2}}{〈 X {\hat{v}}_{j} , X {\hat{v}}_{j} 〉}$$

where \hat{v}ⱼ is the particular parent principal component (i.e., the estimate for the particular parent principal component determined during a previous execution of the process 130), and [symbol] a, b [symbol] represents the dot product (also referred to as the inner product) between a and b.

The system can combine the respective second terms corresponding to each parent principal component to generate a combined second term, e.g., by determining the sum:

$${\sum }_{j < i} \frac{{〈 X {\hat{v}}_{i} , X {\hat{v}}_{j} 〉}^{2}}{〈 X {\hat{v}}_{j} , X {\hat{v}}_{j} 〉}$$

where j<i identifies all principal components of the data set that are parent principal components to the particular principal component.

The utility function can be equal to or proportional to the difference between the first term and the combined second term. That is, the utility function, which can be denoted can be equal to or proportional to:

$${‖ X {\hat{v}}_{i} ‖}^{2} - {\sum }_{j < i} \frac{{〈 X {\hat{v}}_{i} , X {\hat{v}}_{j} 〉}^{2}}{〈 X {\hat{v}}_{j} , X {\hat{v}}_{j} 〉}$$

To determine an update to the current estimate for the particular principal component, the system can determine a gradient of the utility function. For example, the gradient of the above utility function is:

$$2 {X}^{⊤} [ X {\hat{v}}_{i} - {\sum }_{j < i} \frac{〈 X {\hat{v}}_{i} , X {\hat{v}}_{j} 〉}{〈 X {\hat{v}}_{j} , X {\hat{v}}_{j} 〉} X {\hat{v}}_{j} ]$$

The left term within the bracket (i.e., the gradient of the first term of the utility function) is sometimes called a “reward estimate”, while the right term within the bracket (i.e., the gradient of the combined second term of the utility function) is sometimes called a “combined punishment estimate,” where each term in the summation is a “punishment estimate” corresponding to a respective parent principal component.

In different implementations, the system can use different approximations of the above gradient. e.g., to improve efficiency or remove bias.

The gradient of the utility function represents the direction that, if the estimate for the particular principal component were updated in that direction, the value of the utility function would increase the most (i.e., the reward for the particular agent would increase the most). The system can then thus update the current estimate for the particular principal component using the gradient of the utility function. For example, the system can compute:

$${∇}_{{\hat{v}}_{i}}^{R} ← {∇}_{{\hat{v}}_{i}} - 〈 {∇}_{{\hat{v}}_{i}} , {\hat{v}}_{i} 〉 {\hat{v}}_{i} \\ {\hat{v}}_{i}^{′} ← {\hat{v}}_{i} + α {∇}_{{\hat{v}}_{i}}^{R} \\ {\hat{v}}_{i} ← \frac{{\hat{v}}_{i}^{′}}{‖ {\hat{v}}_{i}^{′} ‖}$$

where ∇_{\hat{v}}_{ᵢ} is the gradient of the utility function, α is a hyperparameter representing a step size, and the final computation is performed so that the updated estimate for the principal component is a unit vector (i.e., a vector of length one).

In some implementations, the system does not actually compute a value for the utility function at step 134, but rather only computes the gradient of the utility function.

That is, because only the gradient of the utility function is used to update the estimate for the principal component, the system can save computational resources and increase efficiency by not computing a value for the utility function itself.

The system can repeat step 134 until determining a final estimate for the particular principal component.

In some implementations, the system performs a predetermined number of iterations of step 134. For example, the system can determine to perform ti iterations of step 134 for the ith principal component, where:

$${t}_{i} = ⌈ \frac{5}{4} {min ( \frac{‖ {∇}_{{\hat{v}}_{i}^{0}} {u}_{i} ‖}{2} , {ρ}_{i} )}^{- 2} ⌉$$

where \hat{v}ᵢ⁰ is the initial estimate for the particular principal component obtained at step 132, ρᵢ is a hyperparameter representing an error tolerance, and ∇_{\hat{v}}_{ᵢ}_{⁰}uᵢ is the gradient of the utility function uᵢ evaluated at the initial estimate for the particular principal component. As described above, the goal of the agent corresponding to the particular principal component is to adjust the estimate for the particular principal component in order to maximize a utility function; in some implementations, this utility function can take the shape of a sinusoid. If the agent happens to initialize the estimate for the particular principal component near the “bottom” (“trough”) of the sinusoid, the initial gradient ∇_{\hat{v}}_{ᵢ}_{⁰}uᵢ for updating the estimated principal component is relatively small; therefore, gradient ascent may make slow progress climbing out of the bottom of the sinusoid, thus requiring more iterations. In other words, the smaller the initial gradient ∇_{\hat{v}}_{ᵢ}_{⁰}uᵢ is, the more iterations may be required to climb out from the bottom of the sinusoid.

In some other implementations, the system iteratively performs step 134 for a predetermined amount of time. In some other implementations, the system performs step 134 until a magnitude of the update to the estimate for the particular principal component falls below a predetermined threshold.

After determining the top-k principal components of the data set using respective executions of the process 130, the system can provide the principal components to an external system for storage or further processing. Example techniques for using the principal components of a data set are described below with reference to FIG. 3.

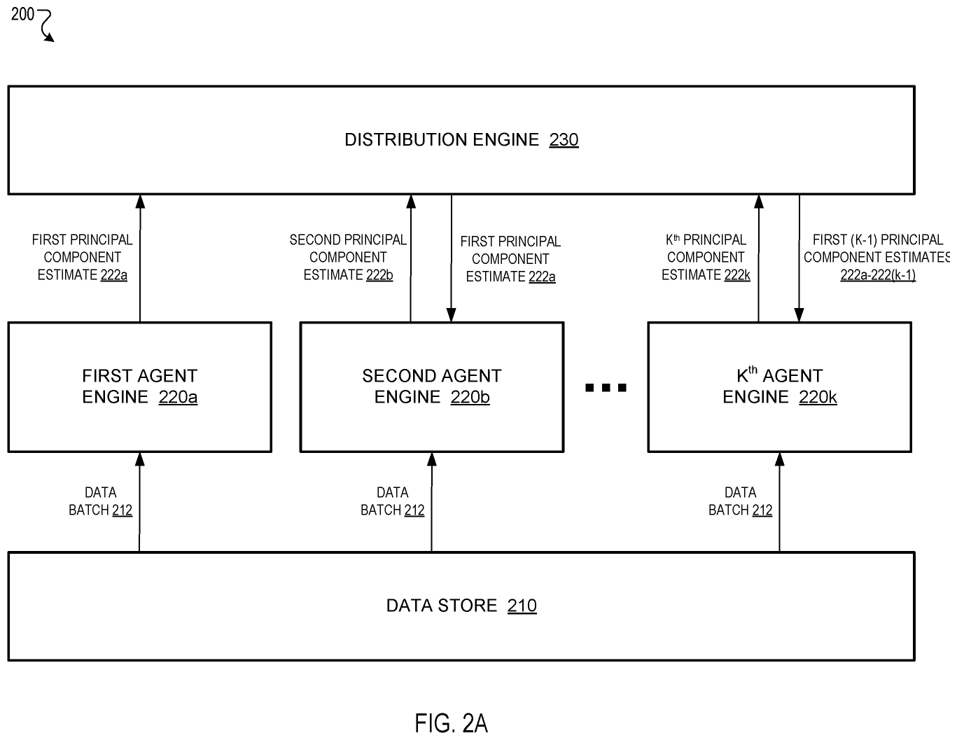

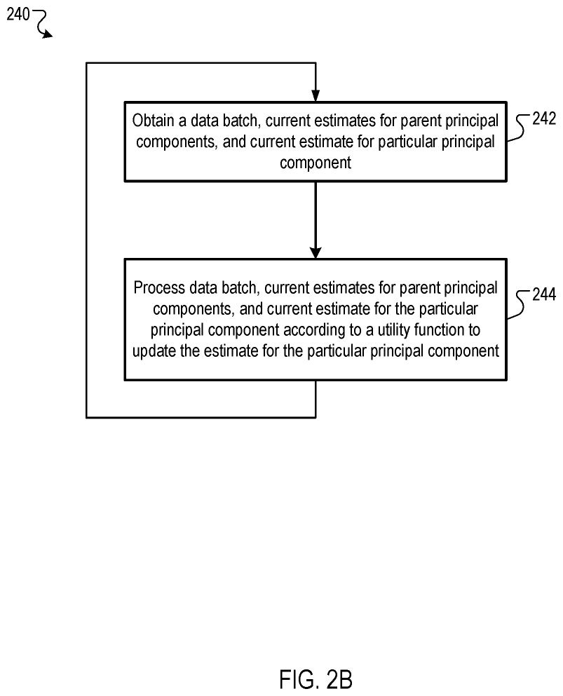

FIG. 2A is a diagram of an example principal component analysis system 200 for determining principal components of a data set in parallel. The principal component analysis system 200 is an example of a system implemented as computer programs on one or more computers in one or more locations, in which the systems, components, and techniques described below can be implemented.

The principal component analysis system 200 is configured to determine the top-k principal components of a data set, where k≥1. The data set has dimensionality n, where n≥k.

The principal component analysis system 200 is configured to determine the top-k principal components of the data set in parallel, by iteratively updating a current estimate 222a-k for each particular principal component using current estimates 222a-k for the other principal components (in particular, using current estimates 222a-k for the parent principal components of the particular principal component).

As described above with reference to FIG. 1A, the principal component analysis system 200 determines the top-k principal components of the data set by modelling the principal component analysis as a multi-agent interaction. The multi-agent interaction includes k agents, each agent corresponding to a respective principal component. Each agent in the multi-agent interaction takes an action by selecting an estimate 222a-k of the corresponding principal component, and receives a reward for the action that incentivizes the agent to select the true corresponding principal component.

In particular, the principal component analysis system 200 defines a utility function for each agent that is a function of (i) the estimate 222a-k of the corresponding principal component identified by the action of the agent and (ii) estimates 222a-k for the parent principal components as identified by the respective actions of the corresponding other agents in the multi-agent interaction. The respective utility function of each agent can reward actions by the agent that identify estimated principal components 222a-k that (i) are orthogonal to the estimates 222a-k for the parent principal components (as identified by the actions of the corresponding other agents) and (ii) identify a direction of maximal variance in the data set (among the directions that are available given the estimates 222a-k for the parent principal components). Example utility functions are discussed in more detail below with reference to FIG. 2B.

The principal component analysis system 200 includes a data store 210, a distribution engine 230, and k agent engines 220a-k. As described below, the k agent engines 220a-k may be configured to operate in parallel.

Each agent engine 220a-k is configured to determine estimates 222a-k for a respective principal component of the data set by selecting an action for the corresponding agent in the multi-agent interaction defined by the principal component analysis system 200. That is, the first agent engine 220a is configured to determine estimates 222a for the first principal component of the data set, the second agent engine 220b is configured to determine estimates 222b for the second principal component of the data set, and so on.

In particular, the agent engines 220a-k are each configured to iteratively update the estimate 222a-k of the corresponding principal component across multiple iterations of the principal component analysis system 200.

The data store 210 is configured to store the data set and, at each iteration of the principal component analysis system 200, provide a new batch 212 of the data set to the agent engines 220a-k. In this specification, a data batch of a data set is any (proper) subset of the elements of the data set.

The distribution engine 230 is configured to maintain the current estimates 222a-kof the principal components of the data set, and distribute the current estimates 222a-k to the agent engines 220a-k. That is, at each iteration of the principal component analysis system 200, the distribution engine 230 (i) obtains the latest updated estimates 222a-k for the principal components and (ii) distributes the latest updated estimates 222a-k to the required agent engines 220a-k. In particular, at each iteration and for each estimate 222a-k of a particular principal component, the distribution engine 230 distributes the estimate 222a-k to each agent engine 220a-k corresponding to a child principal component of the particular principal component.

At each iteration of the principal component analysis system 200, each agent engine 220a-k is configured to obtain a new data batch 212 from the data store 210, and obtain the current estimates 222a-k for the parent principal components of the principal component corresponding to the agent engine 220a-k. The agent engines 220a-k then update the estimates 222a-k of their respective principal components using the obtained data batch 212 and parent principal component estimates 222a-k, and provide the updated estimates 222a-k back to the distribution engine.

Because the first principal component does not have parent principal components, the first agent engine 220a processes only the data batch 212, as described in more detail below, to generate the updated estimate 222a of the first principal component. In particular, the first agent engine 220a processes the data batch 212 to maximize the utility function of the agent in the multi-agent interaction corresponding to the first principal component, selecting an action that represents the updates estimate 222a of the first principal component.

In some implementations, as described in more detail below, the first agent engine 220a determines (e.g. successively) multiple updates to the estimate 222a of the first principal component, and combines the multiple updates to generate the updated estimate 222a of the first principal component. For example, the first agent engine 220a can segment the batch 212 into m sub-batches, where m>1, and determine a respective update the estimate 222a of the first principal component using each sub-batch. In some such implementations, the first agent engine 220a determines each of the multiple updates using a respective different device; that is, the first agent engine 220a can be implemented on multiple different devices that each are configured to determine respective updates to the estimate 222a of the first principal component.

The second agent engine processes the data batch 212 and the estimate 222a for the first principal component, as described in more detail below, to generate the updated estimate 222b of the second principal component. In particular, given the action of the agent corresponding to the first principal component (as represented by the estimate 222a of the first principal component), the second agent engine 22b processes the data batch 212 to maximize the utility function of the agent in the multi-agent interaction corresponding to the second principal component, selecting an action that represents the updated estimate 222b of the second principal component.

Similar to the first agent engine 220a, in some implementations, the second agent engine 220b determines multiple updates to the estimate 222b of the second principal component (e.g., using respective different devices), and combines the multiple updates to generate the updated estimate 222b of the second principal component.

Each agent engine 220a-k generates updated estimates 222a-k of the corresponding principal components as described above, down to the k^{th} agent engine 220k, which processes the data batch 212 and estimates 222a to 222(k−1) of the first k−1 principal components to update the estimate 222k of the k^{th} principal component.

In some implementations, the agent engines 220a-k do not broadcast updated estimates 222a-k to the respective principal components at each iteration of the principal component analysis system. For example, the agent engines 220a-k can broadcast the current estimates 222a-k only after every n updates to the estimates 222a-k, where n≥1. That is, the agent engine 220a-k for each particular principal component can process multiple different batches 212 using the same estimates 222a-k for the parent principal components of the particular principal component, determining multiple respective updates to the particular principal components before providing the latest estimate 222a-kof the particular principal component to the distribution engine 230.

In some implementations, the principal component analysis system 200 does not include a distribution engine 230, and instead the agent engines 220a-k broadcast the estimates 222a-k of the respective principal components directly to each other.

In some other implementations, the operations of the data store 210 and the distribution engine 230 can be executed by the same component of the principal component analysis system 200. For example, the data store 210 can also store the current estimates 222a-k of the principal components and provide the current estimates 222a-k to the agent engines 220a-k.

After determining final estimates 222a-k of the top-k principal components of the data set, the principal component analysis system 200 can provide the principal components to an external system for storage or further processing. Example techniques for using the principal components of a data set are described below with reference to FIG. 3.

In some implementations, each agent engine 220a-k is implemented on a respective different device (or, as described above, multiple different devices) in a system of multiple communicatively coupled devices. The multiple processing devices may be configured to operate in parallel (i.e. at the same time). For example, each agent engine 220a-k can be implemented on one or more respective parallel processing devices, e.g., GPUs. In some other implementations, one or more of the agent engines 220a-k are implemented on the same device.

A parallel processing device may include a plurality of processing cores, which may themselves be considered to be (single-core) processing devices. In some implementations, each agent engine 220a-k is implemented by a respective one of a plurality of processing cores, where the plurality of processing cores are provided by a single parallel processing device, e.g. GPU, or collectively provided by a plurality of parallel processing devices. In other implementations, the agent engines 220a-k are partitioned into groups which each include a plurality of the agent engines 220a-k, and each group of agent engines is implemented by a respective one of the plurality of processing cores.

In all these cases, a plurality of processing devices (which may be a plurality of CPUs, GPUs, or TPUs, or a plurality of cores provided by a single multi-core processing device, or collectively provided by a plurality of multi-core processing devices) operate in parallel for corresponding ones of the principal components v, to generate the successive estimates 222a-k for the principal components v, and in particular to generate the final estimates for the principal components v. As a particular example, the principal component analysis system 200 can execute sets of one or more agent engine 220a-k on respective different processing devices (e.g., each device can execute one, two, five, ten, or 100 agent engines 220a-k).

In some implementations, the operations executed by the agent engines 220a-k described above are executed by the same component of the principal component analysis system 200, e.g., by a single agent engine. That is, in some implementations, the principal component analysis system 200 includes a single agent engine (e.g., that is implemented on a single device) that determines estimates 222a-k for each of the top-k principal components.

FIG. 2B is a flow diagram of an example process 240 for determining principal components of a data set in parallel. For convenience, the process 240 will be described as being performed by a system of one or more computers located in one or more locations. For example, a principal component analysis system, e.g., the principal component analysis system 200 depicted in FIG. 2A, appropriately programmed in accordance with this specification, can perform the process 240.

The system can perform the process 240 described below in parallel for each top-k principal components of the data set. In the description below, the system is described as executing the process 240 to determine a particular principal component.

The system can execute the steps 242 and 244 at each of multiple iterations to update the estimate for the particular principal component.

The system obtains (i) a new data batch from the data set, (ii) current estimates for the parent principal components to the particular principal component, and (iii) the current estimate for the particular principal component (step 242). The current estimates for the parent principal components can have been determined during concurrent executions of the process 240.

At the first iteration of the process 240 for the particular principal component, the system can determine any appropriate initial estimate for the particular principal component and the parent principal components. For example, the system can randomly select an initial estimate for each principal component, e.g., sampling a tensor having the same dimensionality as the data set uniformly at random. As another example, the system can sequentially sample initial estimates for each principal component in order, such that each new sampled initial estimate is orthogonal to the previously-sample initial estimates of the parent principal components.

The system processes the data batch, the current estimates for the parent principal components, and the current estimate for the particular principal component according to a utility function to update the estimate for the particular principal component (step 244).

The system models the determination of the particular principal component as a multi-agent interaction, where a particular agent performs an action that identifies an estimate for the particular principal components, and respective other agents in the multi-agent interaction perform actions that identify the current estimates for the parent principal components to the particular principal components. The system can update the selected action of the particular agent to update the estimate of the particular principal component.

As described above with reference to FIG. 1B, the utility function defines the reward for the particular agent, where a higher reward indicates that the action selected by the particular agent identifies an estimate for the particular principal component that is closer to the true value for the particular principal component. In particular, the utility function can include one or more of (i) one or more first terms that reward the particular agent for selecting an estimate for the particular principal component that captures more variance in the data batch, or (ii) one or more second terms that punish the particular agent for selecting an estimate for the particular principal component that is not orthogonal to the current estimates for the parent principal components of the particular principal component.

As a particular example, the utility function uᵢ for the i-th principal component can be equal to or proportional to:

$${‖ X {\hat{v}}_{i} ‖}^{2} - {\sum }_{j < i} \frac{{〈 X {\hat{v}}_{i} , X {\hat{v}}_{j} 〉}^{2}}{〈 X {\hat{v}}_{j} , X {\hat{v}}_{j} 〉}$$

where X is the data batch of the data set, \hat{v}ᵢ is the current estimate for the particular principal component, and \hat{v}ⱼ is the current estimate for a respective parent principal component.

To determine an update to the current estimate for the particular principal component, the system can determine a gradient or estimated gradient of the utility function. For example, the system can determine the same gradient as described above with reference to FIG. 1B.

As another example, the system can use an approximation of the gradient of the utility function. Using an approximation to the gradient instead of the true gradient can improve the efficiency of the system and/or remove bias from the updates to the estimate of the particular principal component, when the principal components are determined in parallel. In particular, because the parallel updates to the estimates of the principal components rely on estimates for their respective parent principal components instead of the true values for the parent principal components, in some implementations using the true gradient when determining parallel updates can introduce a bias that can cause the estimation of the principal components not to converge to their respective true values, or to converge to their respective true values slowly. The system can therefore use an approximated gradient of the utility function that, while not necessarily equal to the derivative of the utility function with respect to the estimate for the particular principal component, does not introduce bias to the updates thereof. Thus, using the approximated gradient can allow the system to determine the principal components of the data set in parallel, significantly improving the efficiency of the system. In other words, the approximated gradient can allow the system to execute the techniques described here on parallel processing hardware.

As a particular example, the system can compute the following approximated gradient:

$${\tilde{∇}}_{{\hat{v}}_{i}} = {X}^{T} X {\hat{v}}_{i} - {\sum }_{j < i} 〈 X {\hat{v}}_{i} , X {\hat{v}}_{j} 〉 {\hat{v}}_{j}$$

The left term within the bracket is sometimes called a “reward estimate”, while the right term is sometimes called a “combined punishment estimate,” where each term in the summation is a “punishment estimate” corresponding to a respective parent principal component.

The approximated gradient of the utility function represents an approximation of the direction that, if the current estimate for the particular principal component were updated in that direction, the value of the utility function would increase the most (i.e., the reward for the particular agent would increase the most). The system can then thus update the current estimate for the particular principal component using the approximated gradient of the utility function. For example, the system can compute:

$${\tilde{∇}}_{{\hat{v}}_{i}}^{R} ← {\tilde{∇}}_{{\hat{v}}_{i}} - 〈 {\tilde{∇}}_{{\hat{v}}_{i}} , {\hat{v}}_{i} 〉 {\hat{v}}_{i} \\ {\hat{v}}_{i}^{′} ← {\hat{v}}_{i} + {η}_{t} {\tilde{∇}}_{{\hat{v}}_{i}}^{R} \\ {\hat{v}}_{i} ← \frac{{\hat{v}}_{i}^{′}}{‖ {\hat{v}}_{i}^{′} ‖}$$

where \tilde{∇}_{\hat{v}}_{ᵢ} is the approximated gradient of the utility function, ηₜ is a hyperparameter representing a step size, and the final computation is performed so that the updated estimate for the principal component is a unit vector (i.e., a vector of length one). \hat{v}ᵢ In some implementations, the hyperparameter ηₜ depends on the iteration t of the process 240. That is, different executions of the step 244 can use different values for ηₜ. For example, the value of ηₜ can decay across iterations so that later executions of step 244 use smaller step sizes. As a particular example,

$${η}_{t} = \frac{1}{t} .$$

In some implementations, at each execution of the step 244, the system determines multiple different updates to the current estimate of the particular principal component. For example, the system can generate multiple different mini-batches from the data batch (e.g., where each mini-batch includes a different (proper) subset of the elements of the data batch), and determine a respective different update using each mini-batch. The system can then combine the multiple different updates to generate a final update, and generate the updated estimate for the particular principal component using the final update.

That is, the system can determine M different updates \tilde{∇}_{m,\hat{v}}_{ᵢ}, e.g., using the approximated gradient defined above, where M is a positive integer (M>1), and m is an integer variable which takes the values m=1, . . . ,M. The system can then combine the M updates by computing:

$${\tilde{∇}}_{m , {\hat{v}}_{i}}^{R} ← {\tilde{∇}}_{m , {\hat{v}}_{i}} - 〈 {\tilde{∇}}_{m , {\hat{v}}_{i}} , {\hat{v}}_{i} 〉 {\hat{v}}_{i} ∀ m \\ {\tilde{∇}}_{{\hat{v}}_{i}}^{R} ← \frac{1}{M} {\sum }_{m} {\tilde{∇}}_{m , {\hat{v}}_{i}}^{R} \\ {\hat{v}}_{i}^{′} ← {\hat{v}}_{i} + {η}_{t} {\tilde{∇}}_{{\hat{v}}_{i}}^{R} \\ {\hat{v}}_{i} ← \frac{{\hat{v}}_{i}^{′}}{‖ {\hat{v}}_{i}^{′} ‖}$$

In some implementations, the system can distribute the generation of the multiple different updates to respective different devices, improving the efficiency of the system. That is, different devices of the system can process respective mini-batches to generate respective updates to the estimate for the particular principal component.

As described above, in some implementations, the system does not actually compute a value for the utility function at step 244, but rather only computes the gradient or approximated gradient of the utility function.

The system can repeat the steps 242 and 244 until determining a final estimate for the particular principal component.

In some implementations, the system performs a predetermined number of iterations of step 134. For example, the system can determine the number of iterations based on the size of the data set, e.g., such that the system processes each element of the dataset a certain number of times. In some other implementations, the system iteratively performs steps 242 and 244 for a predetermined amount of time. In some other implementations, the system performs step 242 and 244 until a magnitude of the update to the estimate for the particular principal component falls below a predetermined threshold.

After determining the top-k principal components of the data set using respective parallel executions of the process 240, the system can provide the principal components to an external system for storage or further processing. Example techniques for using the principal components of a data set are described below with reference to FIG. 3.

FIG. 3 is a diagram of an example system 300 that includes a principal component analysis system 320. The system 300 is an example of a system implemented as computer programs on one or more computers in one or more locations, in which the systems, components, and techniques described below can be implemented.

The system includes a data store 310, a principal component analysis system 320, and a machine learning system 330.

The data store 310 is configured to maintain a data set 312 that has dimensionality n. The data set 312 can include data objects having any appropriate type. For example, the elements of the data set 312 can represent text data, image data (one or more images, e.g. collected by a camera, e.g. a still camera), audio data (e.g. one or more sound signals, e.g. collected by a microphone), or indeed any type of sensor data.

The principal component analysis system 320 is configured to determine the top-k principal components of the data set 312, k<n. In some implementations, the principal component analysis system 320 determines the top-k principal components sequentially; for example, the principal component analysis system 320 can be configured similarly to the principal component analysis system 100 described above with reference to FIG. 1A. In some other implementations, the principal component analysis system 320 determines the top-k principal components in parallel; for example, the principal component analysis system 320 can be configured similarly to the principal component analysis system 200 described above with reference to FIG. 2A.

After generating the principal components of the data set 312, the principal component analysis system 320 can use the principal components to reduce the dimensionality of the data set 312. That is, for each element of the data set 312, the principal component analysis system 320 can project the element into the coordinate space defined by the top-k principal components, i.e., project the element from dimensionality n to dimensionality k. The system can thus generate a reduced set 322 that includes, for each element of the data set 312, the projected version of the element.

The principal component analysis system 320 can then provide the reduced data set 322 to the data store 310 for storage. In some implementations, the data store 310 maintains the reduced data set 322 instead of the data set 312; that is, the data store 312 removes the data set 312 after generation of the reduced data set 322. Thus, the data store 310 can save computational and memory resources by replacing the data set 312 with the reduced data set 322, because the reduced data set 322 has approximately

$$\frac{k}{n}$$

the size. Thus, the principal component analysis system 320 (e.g. in the form of the principal component analysis system 100 or the principal component analysis system 200) can be used to obtain directly useful data from the data set 312 (e.g. principal components indicative of objects present in at least some images of the data set 312, or present in some of the images of the data set 312 and not in others).

Instead of or in addition to providing the reduced data set 322 to the data store 310, the principal component analysis system 320 can provide the reduced data set 322 to the machine learning system 330, which is configured to perform machine learning using the reduced data set 322.

For example, the machine learning system 330 can process the projected elements of the reduced data set 322 using a clustering machine learning model (e.g., k-nearest-neighbors) to cluster the projected elements, instead of clustering the full-dimensional elements of the data set 312 directly. Thus, the system can significantly improve the time and computational efficiency of the clustering process. Once the clustering machine learning model has been trained it can be used to classify a dataset (e.g. a newly generated or received dataset) such as one or more images, or one or more audio signals, or any other item(s) of sensor data. The classification is based on a plurality of clusters obtained from the clustering machine learning model and a plurality of classifications corresponding to the respective clusters. The classification may proceed by determining the respective magnitudes of the top-k principal components in the dataset, and then determining one of the clusters corresponding to one of the classes.

As another example, the system can use the reduced data set 322 to train a machine learning model. Because the principal components represent the directions of highest variance in the data set 312, by projecting the elements of the data set 312 into the coordinate space defined by the principal components and training the machine learning model using the projected elements, the machine learning system 330 can maximally differentiate the projected elements while improving the memory and computational efficiency of the training. That is, because the projected elements have a lower dimensionality (in some cases, a far lower dimensionality, e.g., 1%, 5%, or 10% as many dimensions), the efficiency of the training improves while still allowing the machine learning model to learn differences between the elements. In some cases, projecting the data points can further prevent the machine learning model from overfitting to the data set 312.

The system can used the reduced data set 322 to train a machine learning model of any appropriate type. For example, the system can use the reduced data set 322 to train one or more of a neural network, a linear regression model, a logistic regression model, a support vector machine, or a random forest model. The trained machine learning model may for example, be used to classify a dataset (e.g. a newly generated or received dataset) such as an image, audio signal, other item of sensor data. The classification may proceed by determining the respective magnitudes of the top-k principal components in the dataset, inputting data characterizing those magnitudes into the trained machine learning models, and then determining a classification of the dataset based on the output of the machine learning model.

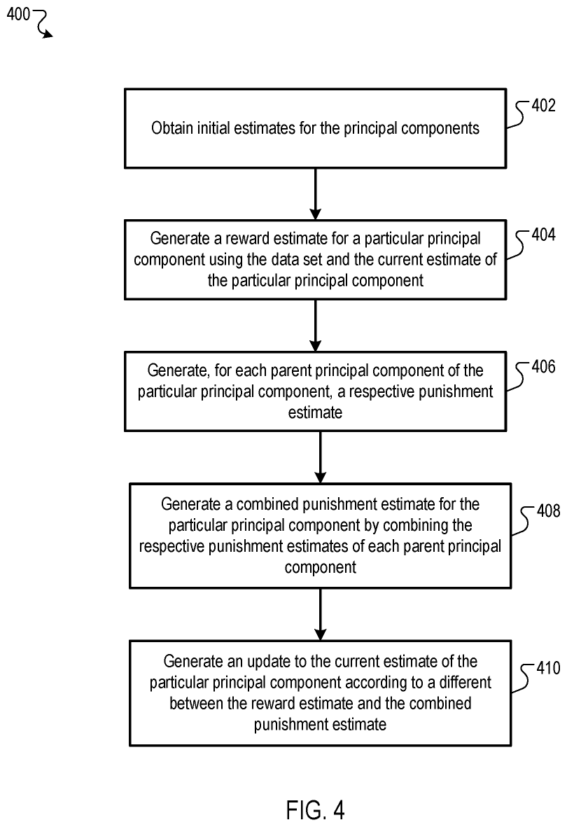

FIG. 4 is a flow diagram of an example process 400 for determining the top-k principal components of a data set. For convenience, the process 400 will be described as being performed by a system of one or more computers located in one or more locations. For example, a principal component analysis system, e.g., the principal component analysis system 100 described above with reference to FIG. 1A, or the principal component analysis system 200 described above with reference to FIG. 2A, appropriately programmed in accordance with this specification, can perform the process 400.

The system obtains initial estimates for the principal components v of the data set X (step 402).

The system can perform the steps 404, 406, 408, and 410 for each of the top-k principal components, e.g., sequentially or in parallel across the principal components, to update a current estimate for each respective principal component. For each principal component, the system can repeatedly perform the steps 404, 406, 408, and 410 to generate a final estimate for the principal component. The below description refers to updating the current estimate for a particular principal component vᵢ.

The system generates a reward estimate using the data set X and the current estimate \hat{v}ᵢ of the particular principal component vᵢ (step 404). The reward estimate is larger if the current estimate \hat{v}ᵢ of the particular principal component vᵢ captures more variance in the data set X.

The system generates, for each parent principal component vⱼ of the particular principal component vᵢ, a respective punishment estimate (step 406). The punishment estimate is larger if the current estimate \hat{v}ᵢ of the particular principal component vᵢ and the current estimate \hat{v}ⱼ of the parent principal component vⱼ are not orthogonal.

The system generates a combined punishment estimate for the particular principal component vᵢ by combining the respective punishment estimates of each parent principal component vⱼ (step 408).

The system generates an update to the current estimate \hat{v}ᵢ of the particular principal component vᵢ according to a difference between the reward estimate and the combined punishment estimate (step 410).

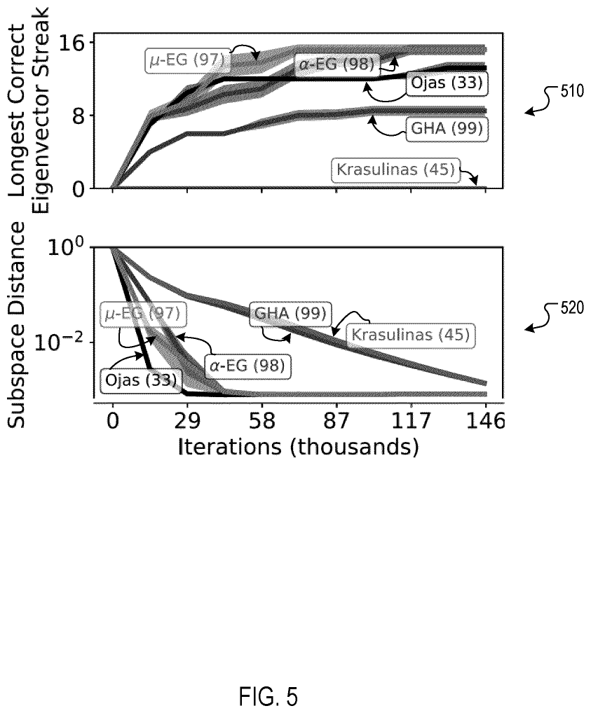

FIG. 5 is an illustration of the performance of respective different principal component analysis systems determining the principal components of a data set.

FIG. 5 illustrates the performance of five different principal component analysis systems: (i) a first principal component analysis system labeled “μ-EG” that uses techniques described in this specification to determine the top-k principal components of the data set in parallel, (ii) a second principal component analysis system labeled “α-EG” that uses techniques described in this specification to determine the top-k principal component of the data set sequentially, (iii) a third principal component analysis system labeled “Ojas” that uses existing techniques to determine the top-k principal components of the data set, (iv) a fourth principal component analysis system labeled “GHA” that uses existing techniques to determine the top-k principal components of the data set, and (v) a fifth principal component analysis system labeled “Krasulinas” that uses existing techniques to determine the top-k principal components of the data set.

FIG. 5 illustrates two graphs 510 and 520 representing respective different performance metrics for the five principal component analysis systems.

The first graph 510 represents, for each principal component analysis system, the “longest correct eigenvalue streak” at each of multiple iterations during the execution of the respective principal component analysis systems. The “longest correct eigenvalue streak” at a particular iteration for a particular principal component analysis system identifies the number of estimated eigenvectors of the covariance matrix of the data set (corresponding to respective estimated principal components) that have been estimated, in order of principal component, to within an angular threshold of the ground-truth eigenvectors of the covariance matrix of the data set. That is, at the particular iteration the particular principal component analysis system generates a set of k estimated principal components, and a “longest correct eigenvalue streak” of s, s≤k, indicates that the first s estimated principal components (i.e., principal components 1 through s) correspond to eigenvectors that are correct to within the angular threshold (e.g., π/8).

As illustrated by the first graph 510, the principal component analysis system with the highest “longest correct eigenvalue streak” at most of the iterations is “μ-EG”, i.e., the principal component analysis system that uses techniques described in this specification to determine the top-k principal components of the data set in parallel. As described above with reference to FIG. 2A and FIG. 2B, the μ-EG principal component analysis system can include multiple agents corresponding to respective principal components of the data set, where each agent iteratively updates the estimate for the corresponding principal component using the respective current estimated principal components generated by the other agents. Thus, the μ-EG principal component analysis system can generate accurate estimates for the top-k principal components, even at relatively early iterations.

The second graph 520 represents, for each principal component analysis system, the “subspace distance” at each of multiple iterations during the execution of the respective principal component analysis systems. The “subspace distance” at a particular iteration for a particular principal component analysis system identifies how well the estimated eigenvectors of the covariance matrix of the data set (corresponding to respective estimated principal components) capture the top-k subspace of the data set, using a normalized subspace distance. That is, at the particular iteration the particular principal component analysis system generates a set of k estimated principal components, and a low “subspace distance” indicates that the estimated eigenvectors corresponding to the estimated principal components define a subspace that is closer to the ground-truth top-k subspace of the data set. In other words, a lower “subspace distance” indicates that the estimated principal components are more accurate.

Given a set of k estimated eigenvectors \hat{v}ᵢ that are estimates of the top-k eigenvectors vᵢ of the data set, the normalized subspace distance can be determined by computing:

$$1 - \frac{1}{k} \cdot Tr ( {U}^{*} \cdot P ) ∈ [ 0 , 1 ]$$

where U*=VV^{†}, V=[v₁, . . . , vₖ], P=\hat{V}\hat{V}^{†}, \hat{V}=[\hat{v}₁, . . . , \hat{v}ₖ], A^{†} is the conjugate transpose of matrix A, and Tr(A) is the trace of matrix A.

As illustrated by the second graph 520, “μ-EG” (i.e., the principal component analysis system that uses techniques described in this specification to determine the top-k principal components of the data set in parallel) and “α-EG” (i.e., the principal component analysis system that uses techniques described in this specification to determine the top-k principal component of the data set sequentially) achieve a relatively low “subspace distance” after relatively few iterations, especially as compared against the existing techniques used by the “GHA” and “Krasulinas” principal component analysis systems. In other words, using techniques described in this specification, a principal component analysis system can quickly generate highly-accurate estimates for the top-k principal components of a data set.

This specification uses the term “configured” in connection with systems and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a data communication network.

In this specification, the term “database” is used broadly to refer to any collection of data: the data does not need to be structured in any particular way, or structured at all, and it can be stored on storage devices in one or more locations. Thus, for example, the index database can include multiple collections of data, each of which may be organized and accessed differently.

Similarly, in this specification the term “engine” is used broadly to refer to a software-based system, subsystem, or process that is programmed to perform one or more specific functions. Generally, an engine will be implemented as one or more software modules or components, installed on one or more computers in one or more locations. In some cases, one or more computers will be dedicated to a particular engine; in other cases, multiple engines can be installed and running on the same computer or computers.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser. Also, a computer can interact with a user by sending text messages or other forms of message to a personal device, e.g., a smartphone that is running a messaging application, and receiving responsive messages from the user in return.

Data processing apparatus for implementing machine learning models can also include, for example, special-purpose hardware accelerator units for processing common and compute-intensive parts of machine learning training or production, i.e., inference, workloads.

Machine learning models can be implemented and deployed using a machine learning framework, e.g., a TensorFlow framework.

Embodiments of the subject matter described in this specification can be implemented in a computing system that includes a back end component, e.g., as a data server, or that includes a middleware component, e.g., an application server, or that includes a front end component, e.g., a client computer having a graphical user interface, a web browser, or an app through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

Embodiment 1 is a method of determining a plurality of principal components v of a data set X, the method comprising:
obtaining initial estimates for the plurality of principal components v; and
for each particular principal component vᵢ, generating a final estimate for the principal component vᵢ by repeatedly performing operations comprising:
   generating a reward estimate using the data set X and the current estimate \hat{v}ᵢ of the particular principal component vᵢ, wherein the reward estimate is larger if the current estimate \hat{v}ᵢ of the particular principal component vᵢ captures more variance in the data set X;
   generating, for each parent principal component vⱼ of the particular principal component vᵢ, a respective punishment estimate, wherein the punishment estimate is larger if the current estimate \hat{v}ᵢ of the particular principal component vᵢ and the current estimate \hat{v}ⱼ of the parent principal component vⱼ are not orthogonal;
   generating a combined punishment estimate for the particular principal component vᵢ by combining the respective punishment estimates of each parent principal component vⱼ; and
   generating an update to the current estimate \hat{v}ᵢ of the particular principal component vᵢ according to a difference between the reward estimate and the combined punishment estimate.

Embodiment 2 is the method of embodiment 1, wherein the final estimates for the principal components v are generated sequentially, in descending order of principal component.

Embodiment 3 is the method of embodiment 2, wherein, for each particular principal component vᵢ, a number of iterations of updating the current estimate \hat{v}ᵢ of the particular principal component vᵢ is equal to:

$$⌈ \frac{5}{4} {min ( ‖ {∇}_{{\hat{v}}_{i}^{0}} {u}_{i} ‖ / 2 , {ρ}_{i} )}^{- 2} ⌉$$

wherein \hat{v}ᵢ⁰ is the initial estimate for the particular principal component vᵢ, uᵢ is a utility estimate for the particular principal component vᵢ computed using the initial estimate \hat{v}ᵢ⁰, and ρᵢ is a maximum error tolerance of the final estimate for the particular principal component vᵢ.

Embodiment 4 is the method of embodiment 3, wherein the utility estimate uᵢ is equal to:

$${‖ X {\hat{v}}_{i} ‖}^{2} - {\sum }_{j < i} \frac{{〈 X {\hat{v}}_{i} , X {\hat{v}}_{j} 〉}^{2}}{〈 X {\hat{v}}_{j} , X {\hat{v}}_{j} 〉}$$

wherein each \hat{v}ⱼ is the final estimate for a respective parent principal component vⱼ of the particular principal component vᵢ.

Embodiment 5 is the method of embodiment 1, wherein the final estimates for the principal components v are generated in parallel across the principal components v.

Embodiment 6 is the method of embodiment 5, wherein, for each particular principal component vᵢ:
computations for generating the final estimate for the principal component vᵢ are assigned to a respective first processing device of a plurality of first processing devices; and
the current estimate \hat{v}ᵢ of the particular principal component vᵢ is broadcast to each other first processing device of the plurality of first processing devices at regular intervals.

Embodiment 7 is the method of any one of embodiments 5 or 6, wherein:
the method further comprises obtaining a subset Xₜ of a plurality of data elements in the data set X; and
generating a reward estimate using the data set X and the current estimate \hat{v}ᵢ of the particular principal component vᵢ comprises generating a reward estimate using the subset Xₜ and the current estimate \hat{v}ᵢ of the particular principal component vᵢ, wherein the reward estimate is larger if the current estimate \hat{v}ᵢ of the particular principal component vᵢ captures more variance in the subset Xₜ.

Embodiment 8 is the method of embodiment 7, wherein, for each particular principal component vᵢ, the reward estimate is proportional to Xₜ\hat{v}ᵢ or Xₜ^{T}Xₜ\hat{v}ᵢ.

Embodiment 8 is the method of any one of embodiments 7 or 8, wherein, for each particular principal component vᵢ:
a direction of the punishment estimate corresponding to each parent principal component vⱼ is equal to a direction of the initial estimate \hat{v}ⱼ of the parent principal component vⱼ.

Embodiment 10 is the method of embodiment 9, wherein the punishment estimate for each parent principal component vⱼ is proportional to [symbol] Xₜ\hat{v}ᵢ, Xₜ\hat{v}ⱼ [symbol] \hat{v}ⱼ.

Embodiment 11 is the method of any one of embodiments 7 or 8, wherein, for each particular principal component vᵢ, the punishment estimate corresponding to each parent principal component vⱼ is proportional to:

$$\frac{〈 {X}_{t} {\hat{v}}_{i} , {X}_{t} {\hat{v}}_{j} 〉}{〈 {X}_{t} {\hat{v}}_{j} , {X}_{t} {\hat{v}}_{j} 〉} {X}_{t} {\hat{v}}_{j}$$

Embodiment 12 is the method of any one of embodiments 1-11, wherein, for each particular principal component vᵢ:
generating a combined punishment estimate for the particular principal component vᵢ comprises determining a sum of the respective punishment estimates of each parent principal component vⱼ.

Embodiment 13 is the method of any one of embodiments 1-12, wherein, for each particular principal component vᵢ, generating an update to the current estimate \hat{v}ᵢ of the particular principal component vᵢ according to a difference between the reward estimate and the combined punishment estimate comprises:
determining an estimated gradient ∇_{\hat{v}}_{ᵢ} of a utility function of the particular principal component vᵢ using the difference between the reward estimate and the combined punishment estimate;
generating an intermediate update ∇_{\hat{v}}_{ᵢ}^{R} that is proportional to ∇_{\hat{v}}_{ᵢ}− [symbol] ∇_{\hat{v}}_{ᵢ}, \hat{v}ᵢ [symbol] \hat{v}ᵢ; and
generating the update to the current estimate \hat{v}ᵢ using the intermediate update

Embodiment 14 is the method of embodiment 13, wherein generating the update to the current estimate \hat{v}ᵢ comprises computing:

\hat{v}′ᵢƒ\hat{v}ᵢ+ηₜ∇_{\hat{v}}_{ᵢ}^{R}

wherein ηₜ is a hyperparameter representing a step size.

Embodiment 15 is the method of embodiment 13, wherein:
generating an update to the current estimate \hat{v}ᵢ of the particular principal component vᵢ further comprises generating, in parallel across a plurality of second processing devices, a plurality of intermediate updates ∇_{\hat{v}}_{ᵢ}_{,m}^{R} using respective different subsets Xₘ of the data set X; and
generating the update to the current estimate \hat{v}ᵢ comprises:
   combining the plurality of intermediate updates ∇_{\hat{v}}_{ᵢ}_{,m}^{R} to generate a combined intermediate update; and
   generating the update to the current estimate \hat{v}ᵢ using the combined intermediate update.

Embodiment 16 is the method of any one of embodiments 13-15, wherein determining the estimated gradient ∇_{\hat{v}}_{ᵢ} using the difference between the reward estimate and the combined punishment estimate comprises:
subtracting the combined punishment estimate from the reward estimate to generate the difference; and
left-multiplying the difference by a factor proportional to Xₜ^{T}.

Embodiment 17 is the method of any one of embodiments 1-16, wherein, for each particular principal component vᵢ:
generating an update to the current estimate \hat{v}ᵢ of the particular principal component vᵢ comprises updating the current estimate to be \hat{v}′ᵢ and normalizing:

$${\hat{v}}_{i} ← \frac{{\hat{v}}_{i}^{′}}{‖ {\hat{v}}_{i}^{′} ‖}$$

Embodiment 18 is the method of any one of embodiments 1-17, further comprising:
using the plurality of principal components v to reduce a dimensionality of the data set X.

Embodiment 19 is the method of any one of embodiments 1-18, further comprising:
using the plurality of principal components v to process the data set Xusing a machine learning model.

Embodiment 20 is the method of any one of embodiments 1-19, in which the data set X comprises one or more of: a set of images collected by a camera or a set of text data.

Embodiment 21 is a system comprising one or more computers and one or more storage devices storing instructions that when executed by the one or more computers cause the one or more computers to perform the method of any one of embodiments 1-20.

Embodiment 22 is a system according to embodiment 21 when dependent upon embodiment 5, comprising a plurality of processing devices, which are configured to operate in parallel for corresponding ones of the principal components v to generate the final estimates for the principal components v.

Embodiment 23 is one or more computer storage media storing instructions that when executed by one or more computers cause the one or more computers to perform the method of any one of embodiments 1-20.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method of determining a plurality of principal components v of a data set X, the method comprising:
obtaining initial estimates for the plurality of principal components v; and
for each particular principal component vᵢ, generating a final estimate for the principal component vᵢ by repeatedly performing operations comprising:
generating a reward estimate using the data set X and the current estimate \hat{v}ᵢ of the particular principal component vᵢ, wherein the reward estimate is larger if the current estimate \hat{v}ᵢ of the particular principal component vᵢ captures more variance in the data set X;
generating, for each parent principal component vⱼ of the particular principal component vᵢ, a respective punishment estimate, wherein the punishment estimate is larger if the current estimate \hat{v}ᵢ of the particular principal component vᵢ and the current estimate \hat{v}ⱼ of the parent principal component vⱼ are not orthogonal;
generating a combined punishment estimate for the particular principal component vᵢ by combining the respective punishment estimates of each parent principal component vⱼ; and
generating an update to the current estimate \hat{v}ᵢ of the particular principal component vᵢ according to a difference between the reward estimate and the combined punishment estimate.

2. The method of claim 1, wherein the final estimates for the principal components v are generated sequentially, in descending order of principal component.

3. The method of claim 2, wherein, for each particular principal component vᵢ, a number of iterations of updating the current estimate \hat{v}ᵢ of the particular principal component vᵢ is equal to:
$$⌈ \frac{5}{4} {min ( ‖ {∇}_{{\hat{v}}_{i}^{0}} {u}_{i} ‖ / 2 , {ρ}_{i} )}^{- 2} ⌉$$
wherein \hat{v}ᵢ⁰ is the initial estimate for the particular principal component vᵢ, uᵢ is a utility estimate for the particular principal component vᵢ computed using the initial estimate \hat{v}ᵢ⁰, and ρᵢ is a maximum error tolerance of the final estimate for the particular principal component vᵢ.

4. The method of claim 3, wherein the utility estimate uᵢ is equal to:
$${‖ X {\hat{v}}_{i} ‖}^{2} - {\sum }_{j < i} \frac{{〈 X {\hat{v}}_{i} , X {\hat{v}}_{j} 〉}^{2}}{〈 X {\hat{v}}_{j} , X {\hat{v}}_{j} 〉}$$
wherein each \hat{v}ⱼ is the final estimate for a respective parent principal component vⱼ of the particular principal component vᵢ.

5. The method of claim 1, wherein the final estimates for the principal components v are generated in parallel across the principal components v.

6. The method of claim 5, wherein, for each particular principal component vᵢ:
computations for generating the final estimate for the principal component vᵢ are assigned to a respective first processing device of a plurality of first processing devices; and
the current estimate \hat{v}ᵢ of the particular principal component vᵢ is broadcast to each other first processing device of the plurality of first processing devices at regular intervals.

7. The method of claim 5, wherein:
the method further comprises obtaining a subset Xₜ of a plurality of data elements in the data set X; and
generating a reward estimate using the data set X and the current estimate \hat{v}ᵢ of the particular principal component vᵢ comprises generating a reward estimate using the subset Xₜ and the current estimate \hat{v}ᵢ of the particular principal component vᵢ, wherein the reward estimate is larger if the current estimate \hat{v}ᵢ of the particular principal component vᵢ captures more variance in the subset Xₜ.

8. The method of claim 7, wherein, for each particular principal component vᵢ, the reward estimate is proportional to Xₜ\hat{v}ᵢ or Xₜ^{T}Xₜ\hat{v}ᵢ.

9. The method of claim 7, wherein, for each particular principal component vᵢ:
a direction of the punishment estimate corresponding to each parent principal component vⱼ is equal to a direction of the initial estimate \hat{v}ⱼ of the parent principal component vⱼ.

10. The method of claim 9, wherein the punishment estimate for each parent principal component vⱼ is proportional to [symbol] Xₜ\hat{v}ᵢ, Xₜ\hat{v}ⱼ [symbol] \hat{v}ⱼ..

11. The method of claim 7, wherein, for each particular principal component vᵢ, the punishment estimate corresponding to each parent principal component vⱼ is proportional to:
$$\frac{〈 {X}_{t} {\hat{v}}_{i} , {X}_{t} {\hat{v}}_{j} 〉}{〈 {X}_{t} {\hat{v}}_{j} , {X}_{t} {\hat{v}}_{j} 〉} {X}_{t} {\hat{v}}_{j}$$

12. The method of claim 1, wherein, for each particular principal component vᵢ:
generating a combined punishment estimate for the particular principal component vᵢ comprises determining a sum of the respective punishment estimates of each parent principal component vⱼ.

13. The method of claim 1, wherein, for each particular principal component vᵢ, generating an update to the current estimate \hat{v}ᵢ of the particular principal component vᵢ according to a difference between the reward estimate and the combined punishment estimate comprises:
determining an estimated gradient ∇_{\hat{v}}_{ᵢ} of a utility function of the particular principal component vᵢ using the difference between the reward estimate and the combined punishment estimate;
generating an intermediate update ∇_{\hat{v}}_{ᵢ}^{R} that is proportional to ∇_{\hat{v}}_{ᵢ}− [symbol] ∇_{\hat{v}}_{ᵢ}, \hat{v}ᵢ [symbol] \hat{v}ᵢ; and
generating the update to the current estimate \hat{v}ᵢ using the intermediate update ∇_{\hat{v}}_{ᵢ}^{R}.

14. The method of claim 13, wherein generating the update to the current estimate \hat{v}ᵢ comprises computing:
\hat{v}′ᵢƒ\hat{v}ᵢ+ηₜ∇_{\hat{v}}_{ᵢ}^{R}
wherein ηₜ is a hyperparameter representing a step size.

15. The method of claim 13, wherein:
generating an update to the current estimate \hat{v}ᵢ of the particular principal component vᵢ further comprises generating, in parallel across a plurality of second processing devices, a plurality of intermediate updates ∇_{\hat{v}}_{ᵢ}_{,m}^{R} using respective different subsets Xₘ of the data set X; and
generating the update to the current estimate \hat{v}ᵢ comprises:
combining the plurality of intermediate updates ∇_{\hat{v}}_{ᵢ}_{,m}^{R} to generate a combined intermediate update; and
generating the update to the current estimate \hat{v}ᵢ using the combined intermediate update.

16. The method of claim 13, wherein determining the estimated gradient ∇_{\hat{v}}_{ᵢ} using the difference between the reward estimate and the combined punishment estimate comprises:
subtracting the combined punishment estimate from the reward estimate to generate the difference; and
left-multiplying the difference by a factor proportional to Xₜ^{T}.

17. The method of claim 1, wherein, for each particular principal component vᵢ:
generating an update to the current estimate \hat{v}ᵢ of the particular principal component vᵢ comprises updating the current estimate to be \hat{v}′ᵢ and normalizing:
$${\hat{v}}_{i} ← \frac{{\hat{v}}_{i}^{′}}{‖ {\hat{v}}_{i}^{′} ‖}$$

18. The method of claim 1, further comprising:
using the plurality of principal components v to reduce a dimensionality of the data set X

19. The method of claim 1, further comprising:
using the plurality of principal components v to process the data set X using a machine learning model.

20. The method of claim 1, in which the data set X comprises one or more of: a set of images collected by a camera or a set of text data.

21. A system comprising one or more computers and one or more storage devices storing instructions that when executed by the one or more computers cause the one or more computers to perform operations for determining a plurality of principal components v of a data set X, the operations comprising:
obtaining initial estimates for the plurality of principal components v; and
for each particular principal component vᵢ, generating a final estimate for the principal component vᵢ by repeatedly performing operations comprising:
generating a reward estimate using the data set X and the current estimate \hat{v}ᵢ of the particular principal component vᵢ, wherein the reward estimate is larger if the current estimate \hat{v}ᵢ of the particular principal component vᵢ captures more variance in the data set X;
generating, for each parent principal component vⱼ of the particular principal component vᵢ, a respective punishment estimate, wherein the punishment estimate is larger if the current estimate \hat{v}ᵢ of the particular principal component vᵢ and the current estimate \hat{v}ⱼ of the parent principal component vⱼ are not orthogonal;
generating a combined punishment estimate for the particular principal component vᵢ by combining the respective punishment estimates of each parent principal component vⱼ; and
generating an update to the current estimate \hat{v}ᵢ of the particular principal component vᵢ according to a difference between the reward estimate and the combined punishment estimate.

22. (canceled)

23. One or more non-transitory computer-readable storage media storing instructions that when executed by one or more computers cause the one or more computers to perform operations for determining a plurality of principal components v of a data set X, the operations comprising:
obtaining initial estimates for the plurality of principal components v; and
for each particular principal component vᵢ, generating a final estimate for the principal component vᵢ by repeatedly performing operations comprising:
generating a reward estimate using the data set X and the current estimate \hat{v}ᵢ of the particular principal component vᵢ, wherein the reward estimate is larger if the current estimate \hat{v}ᵢ of the particular principal component vᵢ captures more variance in the data set X;
generating, for each parent principal component vⱼ of the particular principal component vᵢ, a respective punishment estimate, wherein the punishment estimate is larger if the current estimate \hat{v}ᵢ of the particular principal component vᵢ and the current estimate \hat{v}ⱼ of the parent principal component vⱼ are not orthogonal;
generating a combined punishment estimate for the particular principal component vᵢ by combining the respective punishment estimates of each parent principal component vⱼ; and
generating an update to the current estimate \hat{v}ᵢ of the particular principal component vᵢ according to a difference between the reward estimate and the combined punishment estimate.
